(19) United States
(12) Patent Application Publication
(10) Pub. No.: US 2017/0213668 A1
(43) Pub. Date: Jul. 27, 2017

(54) KEY SWITCH DEVICE, KEYBOARD, AND ASSEMBLY METHOD FOR KEY SWITCH DEVICE

(71) Applicant: FUJITSU COMPONENT LIMITED, Tokyo (JP)

(72) Inventor: Daisuke YAMASHITA, Tokyo (JP)

(73) Assignee: FUJITSU COMPONENT LIMITED, Tokyo (JP)

(21) Appl. No.: 15/328,794

(22) PCT Filed: May 12, 2015
(86) PCT No.: PCT/JP2015/063670

§ 371 Date: Jan. 24, 2017

(30) Foreign Application Priority Data
Aug. 1, 2014 (JP) 2014-157891

(51) Int. Cl. H01H 13/83; H01H 13/14; H01H 13/88

(52) U.S. Cl. CPC H01H 13/83; H01H 13/88; H01H 13/14; H01H 2219/062; H01H 2219/03

(57) ABSTRACT

A key switch device includes: a key top; a pair of link members that vertically raises and lowers the key top in conjunction with each other; a frame member that includes a leg portion and a through hole, and rotatably fixes the pair of link members; a housing panel that includes a first surface to which the pair of link members and the frame member are fixed, a second surface that is a back side of the first surface, a through hole into which the leg portion is inserted, a through hole which the dome rubber penetrates, and a projection-shaped screw hole formed on the second surface; a membrane sheet on which the dome rubber is mounted, and that is opposite to the second surface; a support plate opposite to the second surface via the membrane sheet, and a screw fastened to a screw hole.

### TECHNICAL FIELD

The present invention relates to a key switch device to be used for key input, a keyboard, and an assembly method for the key switch device.

### BACKGROUND ART

There has been known a key switch device having a gear link mechanism in which a pair of link members coupled interlockably with each other by engaging the respective ends thereof with each other (see Patent Document 1).

FIG. 1 is a diagram of the configuration of a conventional key switch device. FIG. 2 is a diagram illustrating a housing panel on which the key switch device is mounted. FIG. 3A is a cross-section view of a membrane sheet. FIG. 3B is a cross-section view of the key switch device and the housing panel when the key switch device of FIG. 1 is mounted on the housing panel.

As illustrated in FIG. 1, a key switch device 1 includes: a key top 2; a pair of link members 3 that supports the key top 2, and vertically raises and lowers the key top 2 in conjunction with each other; a membrane sheet 4 including a contact described later; a support plate 5 which is foundation structure of the key switch device 1; a frame member 6 that fixedly mounts one ends of the link members 3 on the support plate 5.

A hole 10a corresponding to each key is formed on a housing panel 10 of FIG. 2. In FIG. 2, the hole 10a is illustrated by a solid line, and the key top 2 arranged on the hole 10a is illustrated by a dotted line. The size (area) of the hole 10a is larger than that of the key top 2 arranged on the hole 10a.

The membrane sheet 4 includes a pair of sheet substrates 4c and 4d, and a pair of contacts 4e functioning as a switch, as illustrated in FIG. 3A. The sheet substrates 4c and 4d are away from each other by a predetermined distance, and spacers 4f are provided between the sheet substrates 4c and 4d. The pair of contacts 4e is formed opposite to each other and at positions of the sheet substrates 4c and 4d on which the spacers 4f are not provided. A dome rubber 4b as a reaction force generating member is mounted on the membrane sheet 4.

When the key switch device 1 is assembled, rotational shaft portions 3a of the pair of link members 3 are rotatably fitted in bearing portions 6a of the frame member 6. Then, leg portions 6b of the frame member 6 in which the pair of link members 3 is rotatably fitted are inserted into holes 5a of the support plate 5 via through holes 4a provided on the membrane sheet 4, and are caulked. Moreover, in a state where the dome rubber 4b is mounted on the membrane sheet 4, projection-shaped sliding portions 3b provided on the link member 3 are fitted into guide portions 2a provided on a rear surface of the key top 2. Next, a structure body in which the key top 2, the membrane sheet 4, the link members 3 and the frame member 6 are mounted on the support plate 5 is fixed to a rear surface of the housing panel 10 of FIG. 2. In this case, the membrane sheet 4 is bonded to the rear surface of the housing panel 10 by a double-sided tape or an adhesive 9. Thereby, the assembly of the key switch device 1 is completed. FIG. 3B illustrates a cross-section surface of the key switch device 1 and the housing panel 10 after the assembly is completed.

### PRIOR ART DOCUMENT

[Patent Document 1] Japanese Laid-open Patent Publication No. 2009-76321

As described above, when the conventional key switch device 1 is mounted on the housing panel 10, the membrane sheet 4 is bonded to the rear surface of the housing panel 10 by the double-sided tape or adhesive 9 (see FIG. 3B). Therefore, the membrane sheet 4 warps or transforms, and hence a state keeping on turning on the contact 4e, i.e., a state keeping on turning on the key (hereinafter referred to as “a key-on state”) might occur.

### SUMMARY OF THE INVENTION

It is an object of the present invention to provide a key switch device, a keyboard, and an assembly method for the key switch device that can suppress the occurrence of the key-on state.

To achieve the above-mentioned object, a key switch device disclosed herein characterized by including: a key top having an operation surface; a pair of link members that vertically raises and lowers the key top in conjunction with each other; a frame member that includes a leg portion extending vertically downward and a first through hole which a reaction force generating member generating a reaction force against a depression force of the key top penetrates, and rotatably fixes the pair of link members; a panel that includes a first surface to which the frame member is fixed, a second surface that is a back side of the first surface, a second through hole into which the leg portion is inserted, a third through hole which the reaction force generating member penetrates, and a projection-shaped fastened portion formed on the second surface; a sheet on which the reaction force generating member is mounted, that is opposite to the second surface and includes a fourth through hole that is fitted to the fastened portion; a support plate that is opposite to the second surface via the sheet, and includes a fifth through hole that is fitted to the fastened portion; and a fastening member that is fastened to the fastened portion.

An assembly method for a key switch device disclosed herein, including: mounting, on a first surface of a panel which is mounted on a housing of an information processing apparatus, a pair of link members that raises and lowers a key top in conjunction with each other and a frame member in which a part of the pair of link members is fitted; and mounting a sheet and a support panel on a second surface of the panel by arranging the sheet, on which a reaction force generating member generating a reaction force against a depression force of the key top is mounted, so as to be opposite to the second surface of the panel which is a back side of the first surface, arranging the support panel so as to be opposite to the second surface via the sheet, and fastening a fastening member to a fastened portion formed on the second surface.

According to the present invention, it is possible to suppress the occurrence of the key-on state.

### BRIEF DESCRIPTION OF THE DRAWINGS

FIG. 1 is a diagram illustrating the configuration of a conventional key switch device;

FIG. 2 is a diagram illustrating a housing panel on which the key switch device of FIG. 1 is mounted;

FIG. 3A is a cross-section diagram of a membrane sheet;

FIG. 3B is a cross-section diagram of the key switch device and the housing panel when the key switch device of FIG. 1 is mounted on the housing panel;

FIG. 4 is a diagram illustrating the configuration of a key switch device according to a first embodiment;

FIG. 5 is a cross-section diagram of key switch device taken along line A-A of FIG. 4;

FIG. 6A is a diagram illustrating an example of the housing panel;

FIG. 6B is a diagram illustrating an example in which the housing panel is mounted on a housing of an information processing apparatus;

FIG. 7 is a cross-section diagram of a membrane sheet;

FIG. 8 is a flowchart illustrating an assembly method for the key switch device; and

FIG. 9 is a diagram illustrating the configuration of a key switch device according to a second embodiment.

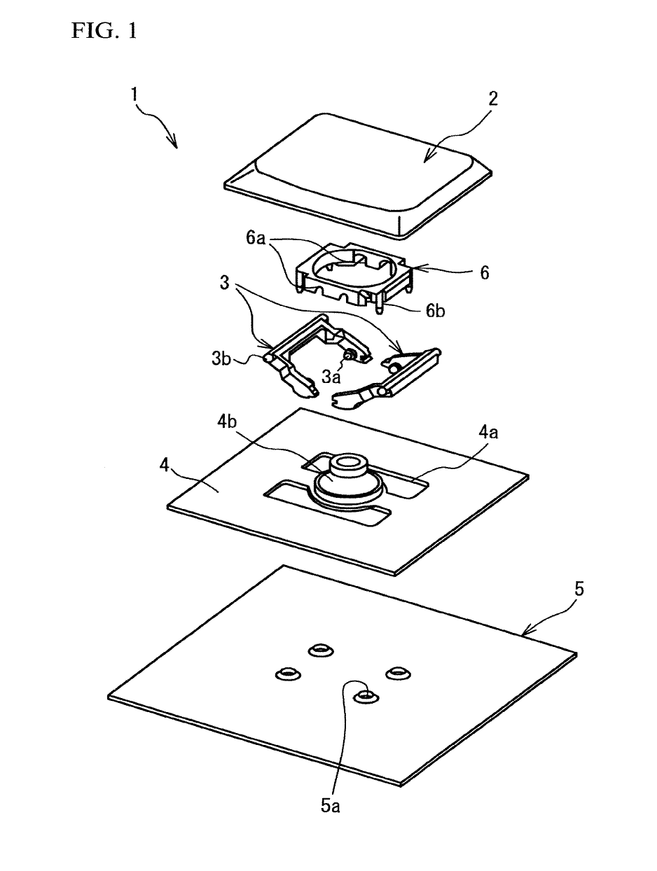

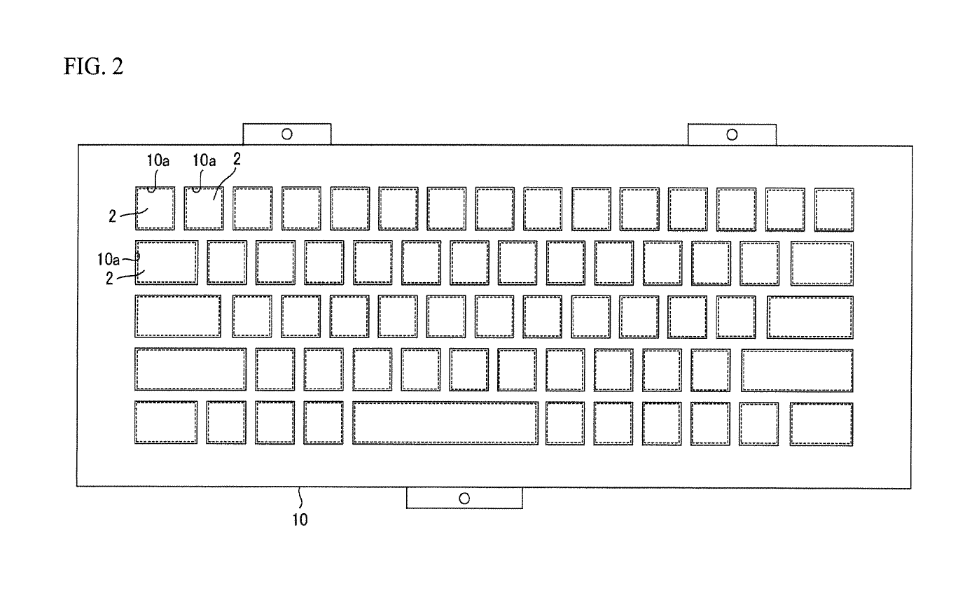

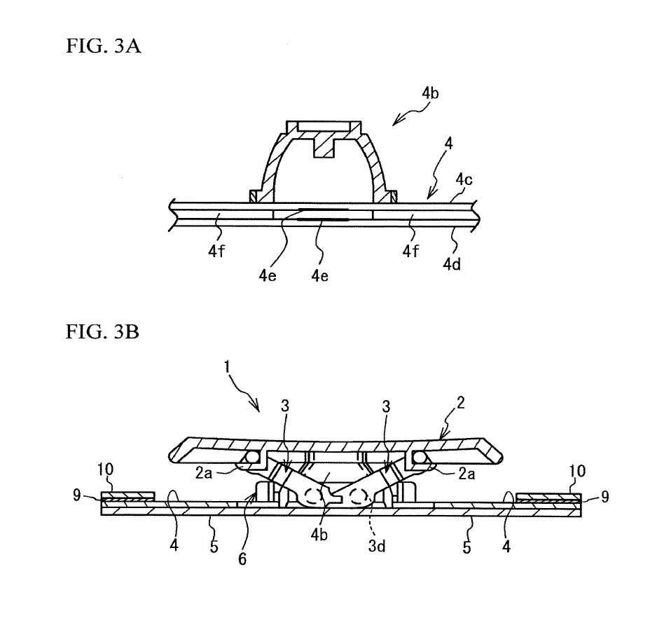

### DETAILED DESCRIPTION

Hereinafter, a description will be given of embodiments with drawings.

### First Embodiment

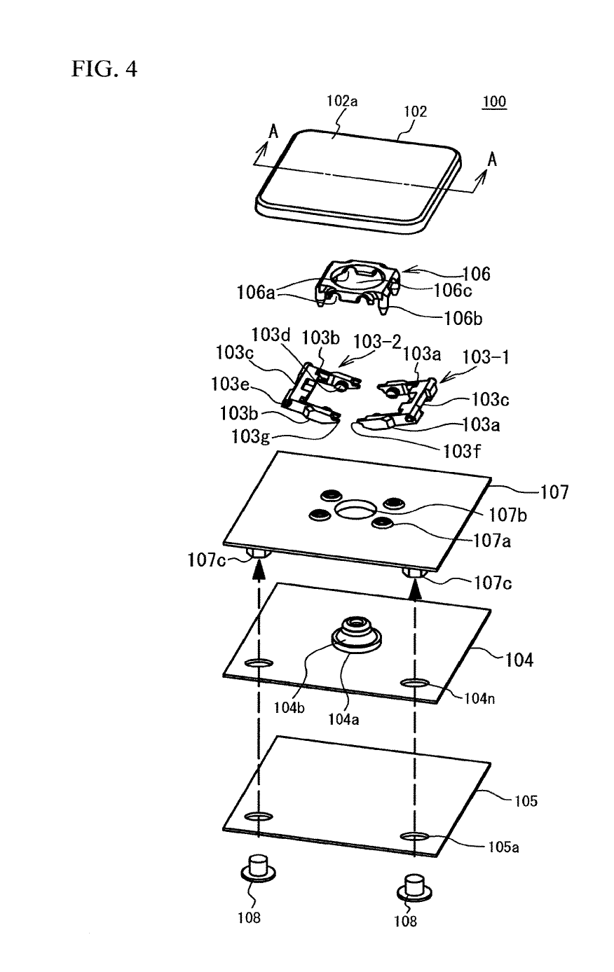

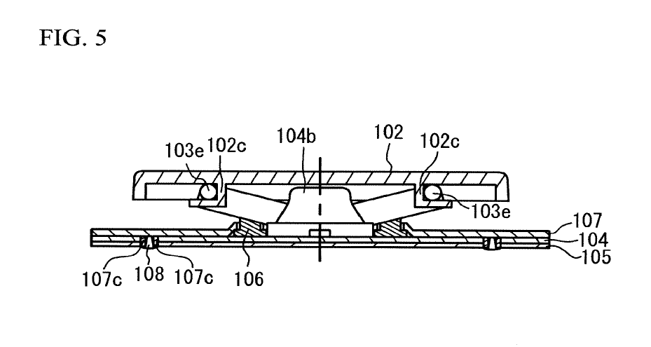

FIG. 4 is a diagram illustrating the configuration of a key switch device according to a first embodiment. FIG. 5 is a cross-section diagram of key switch device taken along line A-A of FIG. 4.

A key switch device 100 includes: a key top 102 having an operation surface 102a which an operator depresses; a pair of link members 103-1 and 103-2 that supports the key top 102, and vertically raises and lowers the key top 102 in conjunction with each other; a membrane sheet 104 including a contact described later that functions as a switch; a tabular support plate 105 which is foundation structure of the key switch device 100; a frame member 106 that fixedly mounts one ends of the link members 103-1 and 103-2 on the support plate 105; and a housing panel 107 that is mounted on a housing of an information processing apparatus such as a notebook computer and a mobile terminal.

Bearing portions 106a in which rotational shaft portions 103d of the link members 103-1 and 103-2 are rotatably fitted are formed on the frame member 106. Moreover, the frame member 106 includes: leg portions 106b each of which is inserted in a through hole 107a of the housing panel 107, is caulked and extends vertically downward; and a through hole 106c (first through hole) exposing an opening end 104a of the membrane sheet 104 and a dome rubber 104b when the frame member 106 is mounted on the support plate 105.

The housing panel 107 is a tabular panel, and includes through holes 107a (second through hole) into which the leg portions 106b of the frame member 106 are inserted, and a through hole 107b (third through hole) exposing the opening end 104a of the membrane sheet 104 and the dome rubber 104b. Here, it is assumed that a surface of the housing panel 107 on which the frame member 106 is mounted is a front surface and a surface of the housing panel 107 opposite to the membrane sheet 104 is a rear surface. Screw holes 107c (fastened portion) for screwing the membrane sheet 104 and the support plate 105 with screws 108 (fastening member) are provided on the rear surface of the housing panel 107. The screw holes 107c are provided so as to project from the rear surface of the housing panel 107.

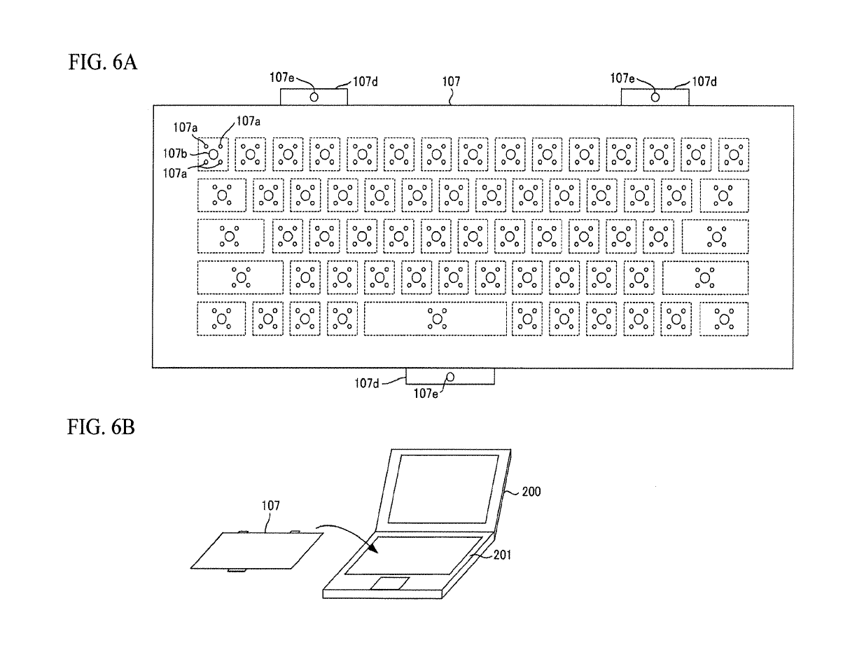

FIG. 6A illustrates an example of the housing panel 107, and FIG. 6B illustrates an example in which the housing panel 107 is mounted on a housing 201 of an information processing apparatus 200. Each of dotted lines of FIG. 6A indicates a position where the key top 102 is put. As illustrated in FIG. 6A, four through holes 107a and one through hole 107b are formed on the housing panel 107 for each key. Moreover, the housing panel 107 includes tabs 107d for mounting the housing panel 107 on the housing 201 of the information processing apparatus 200. Formed on the tab 107d is a through hole 107e for screwing the tab 107d to the housing 201 of the information processing apparatus 200, or inserting a pin (not shown) projected from the housing 201 of the information processing apparatus 200 to fix the housing panel 107 by caulking the pin.

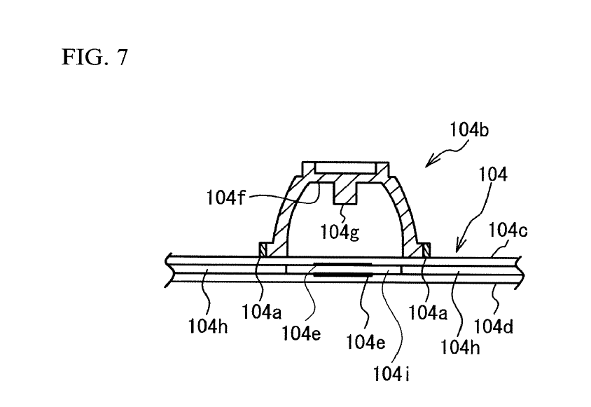

Referring to FIG. 4, the membrane sheet 104 is made of a transparent material, includes the opening end 104a, and includes through holes 104n (a fourth hole) at positions opposite to the screw holes 107c of the housing panel 107. The dome rubber 104b as a reaction force generating member that generates a reaction force against a depression force of the key top 102 is mounted on the opening end 104a. FIG. 7 indicates is a cross-section diagram of the membrane sheet 104. As illustrated in FIG. 7, the membrane sheet 104 includes a pair of sheet substrates 104c and 104d, and a pair of contacts 104e functioning as a switch. The contacts 104e are provided on the sheet substrates 104c and 104d, respectively, and are paired. When the contact 104e of the sheet substrate 104c contacts the contact 104e of the sheet substrate 104d, the contacts 104e become an ON-state. The sheet substrates 104c and 104d are away from each other by a predetermined distance, and a spacer 104h is provided therebetween. The contacts 104e as the pair are formed at positions of an opening 104i provided in the spacer 104h and at the positions on the sheet substrates 104c and 104d, respectively, so as to be opposite to each other. A projection 104g is formed on a ceiling portion 104f of the dome rubber 104b. When the key top 2 is depressed, the dome rubber 104b performs buckling deformation, and the projection 104g depresses the contact 104e. Thereby, the key input is performed.

Referring to FIG. 4, the support plate 105 includes through holes 105a (fifth through hole) at positions opposite to the screw holes 107c of the housing panel 107.

The pair of link members 103-1 and 103-2 of FIG. 4 is made of resin, and one ends of the link members 103-1 and 103-2 engage with each other and are interlockably combined. When the key top 102 is at an upper limit position of a raising and lowering operation, the link members 103-1 and 103-2 have V-shaped gear link structure indicating a shape of a V-character in a side view. The link member 103-1 includes a pair of arm portions 103a extending in substantially parallel with each other in the same direction, and a body portion 103c coupling the arm portions 103a with each other. The link member 103-2 includes a pair of arm portions 103b extending in substantially parallel with each other in the same direction, and a body portion 103c coupling the arm portions 103b with each other.

In FIG. 4, in the link member 103-1, terminal ends of both arm portions 103a away from the body portion 103c and peripheral areas thereof are defined as first end areas of the link member 103-1. In the link member 103-2, terminal ends of both arm portions 103b away from the body portion 103c and peripheral areas thereof are defined as first end areas of the link member 103-2. Moreover, base ends of both arm portions 103a adjacent to the body portion 103c and peripheral areas thereof are defined as second end areas of the link member 103-1. Base ends of both arm portions 103b adjacent to the body portion 103c and peripheral areas thereof are defined as second end areas of the link member 103-2.

A pair of projection-shaped rotational shaft portions 103d are provided on the first end areas of the link member 103-1 and inside surfaces of the pair of arm portions 103a opposite to each other, respectively. A pair of projection-shaped rotational shaft portions 103d are provided on the first end areas of the link member 103-2 and inside surfaces of the pair of arm portions 103b opposite to each other, respectively. Moreover, a pair of projection-shaped sliding portions 103e are provided on the second end areas of the link member 103-1 and outside surfaces of the pair of arm portions 103a away from each other. Moreover, a pair of projection-shaped sliding portions 103e are provided on the second end areas of the link member 103-2 and outside surfaces of the pair of arm portions 103b away from each other. Additionally, first tooth portions 103f are provided on the pair of arm portions 103a and the first end areas of the link member 103-1. Second tooth portions 103g are provided on the pair of arm portions 103b and the first end areas of the link member 103-2.

The pair of rotational shaft portions 103d of the first end areas are rotatably fitted in the bearing portions 106a of the frame member 106, and the pair of shifting portions 103e of the second end areas are slidably fitted in guide portions 102c provided on the rear surface of the key top 102, and hence each of the link members 103-1 and 103-2 is arranged between the membrane sheet 104 and the key top 102. In this case, the first tooth portions 103f and the second tooth portions 103g engage and interlock with each other. Thereby, the link members 103-1 and 103-2 interlock and rotate around the rotational shaft portions 103d each other.

As illustrated in FIG. 5, guide portions 102c which horizontally guide the sliding portions 103e of the link members 103 are formed on the rear surface of the key top 102.

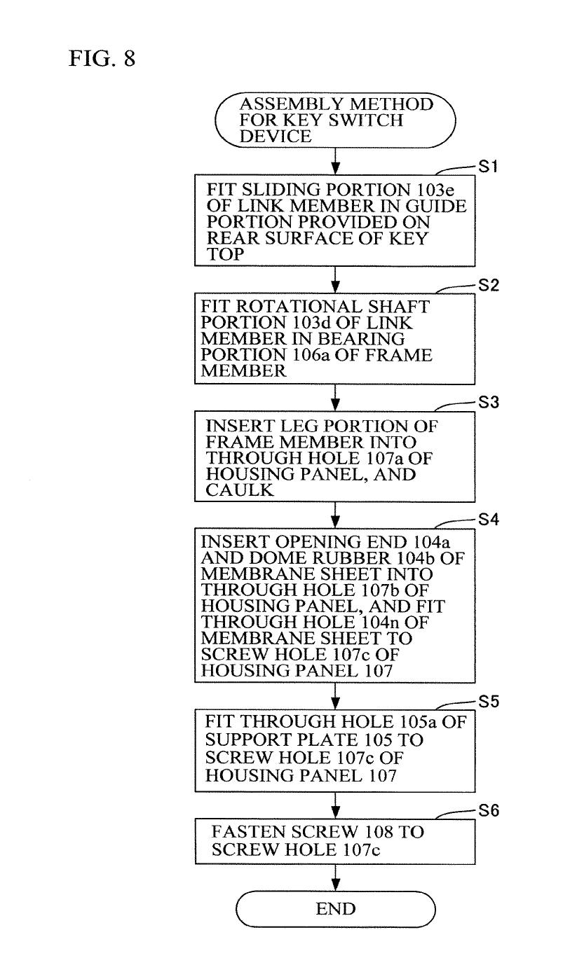

FIG. 8 is a flowchart illustrating an assembly method for the key switch device 100. The placement of parts is really reversed to the placement of FIG. 4 when the key switch device 100 is assembled. That is, the key top 102 is placed at a bottom position. The frame member 106, the link members 103, the housing panel 107 and the membrane sheet 104 are placed in this order. The support plate 105 is placed at a top position. The assembly method for the key switch device 100 is performed using well-known assembling equipment.

First, the sliding portions 103e of the link members 103-1 and 103-2 are fitted in the guide portions 102c provided on the rear surface of the key top 102 (step S1). Next, the frame member 106 is arranged in a substantially center of the rear surface of the key top 102, and the rotational shaft portions 103d of the link members 103-1 and 103-2 are fitted in the bearing portions 106a of the frame member 106 (step S2). Next, the leg portions 106b of the frame member 106 in which the link members 103-1 and 103-2 are fitted are inserted into the through holes 107a of the housing panel 107 and caulked (by heating) (step S3). Thereby, the key top 102, the link members 103-1 and 103-2 and the frame member 106 are fixed to the front surface of the housing panel 107.

Next, the opening end 104a and the dome rubber 104b of the membrane sheet 104 are inserted into the through hole 107b of the housing panel 107, and the through holes 104n of the membrane sheet 104 are fitted to the screw holes 107c projected from the rear surface of the housing panel 107 (step S4). Next, the through holes 105a of the support plate 105 are fitted to the screw holes 107c projected from the rear surface of the housing panel 107 (step S5). Finally, the screws 108 is fastened to the screw holes 107c (step S6). Thereby, the membrane sheet 104 and the support plate 105 are fixed to a rear surface side of the housing panel 107.

According to a conventional assembly method, the key top is mounted on the link members in a state where the dome rubber is mounted on the membrane sheet. Therefore, the key top contacts the dome rubber at the time of the mounting of the key top, and the dome rubber may incline and damage.

On the contrary, according to the assembly method of FIG. 8, the key top 102, the link members 103-1 and 103-2, and the frame member 106 are fixed to a front surface side of the housing panel 107, and then the dome rubber 104b mounted on the membrane sheet 104 is inserted into the through hole 106c of the frame member 106 and the through hole 107b of the housing panel 107 from the rear surface side of the housing panel 107. Therefore, the dome rubber 104b does not contact the key top 102, and hence the inclination and the damage of the dome rubber 104b can be avoided.

### Second Embodiment

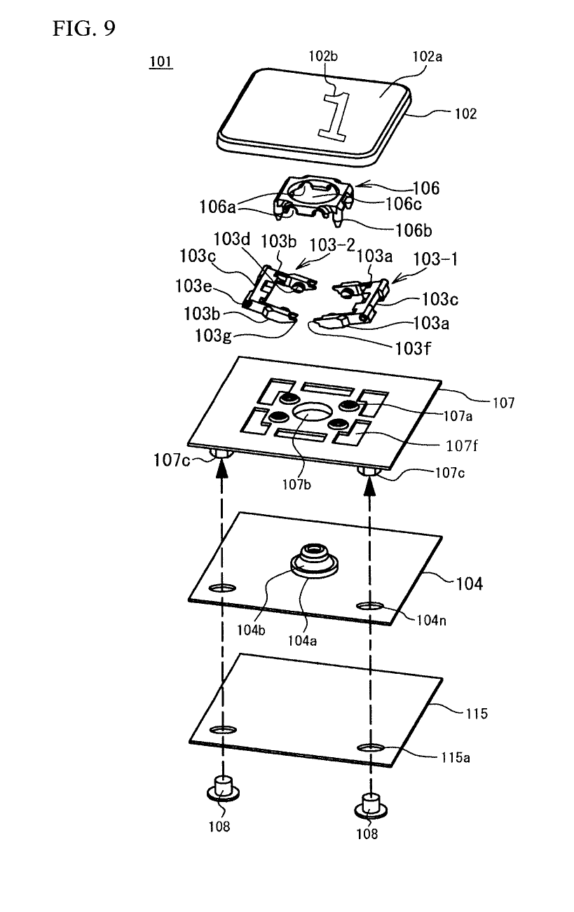

In a second embodiment, a description will be given of features different from the first embodiment. FIG. 9 is a diagram illustrating the configuration of a key switch device according to the second embodiment.

In a key switch device 101 of FIG. 9, an optical guide plate 115 is used as substitute for the support plate 105. The optical guide plate 115 includes through holes 115a at positions opposite to the screw holes 107c of the housing panel 107. The optical guide plate 115 is connected to a light emitting source, not shown, and emits a light from the light emitting source. Since the membrane sheet 104 is transparent, the membrane sheet 104 transmits the light from the optical guide plate 115 toward the housing panel 107. Through holes 107f (sixth through hole) passing the light therethrough are provided on the housing panel 107 so as to surround four through holes 107a. Here, the shape and the number of through holes 107f are not limited to an example of FIG. 9. A character 102b (including a number, a sign or the like) processed transparently by laser processing to transmit the light is formed on the operation surface 102a of the key top 102.

Except for the above, the construction of the key switch device 101 is the same as that of the key switch device 100 of the first embodiment. Moreover, an assembly method for the key switch device 101 is the same as the assembly method for the key switch device 100 of FIG. 8.

According to the second embodiment, the light from the optical guide plate 115 passes through the membrane sheet 104, passes through the through holes 107f and the character 102b processed transparently, and reaches the eyes of an operator. Therefore, an illumination type key switch device can be provided.

In the above-mentioned first embodiment and the second embodiment, the projection-shaped screw holes 107c are formed on the rear surface of the housing panel 107, the screws 108 are fastened to the screw holes 107c, and hence the membrane sheet 104 and the support plate 105 are fixed to the rear surface of the housing panel 107. However, a method for fixing the membrane sheet 104 and the support plate 105 to the rear surface of the housing panel 107 is not limited to this. For example, holes having no thread are formed as substitute for the screw holes 107c, and pins having heads may be press-fitted into the holes having no thread or rivets may be fitted in the holes having no thread and caulk the heads of the rivets.

As described above, according to the above-mentioned embodiment, the key switch device 100 includes: the key top 102 having the operation surface 102a; the pair of link members 103-1 and 103-2 that vertically raises and lowers the key top 102 in conjunction with each other; the frame member 106 that includes the leg portions 106b extending vertically downward and the through hole 106c exposing the dome rubber 104b which generates the reaction force against the depression force of the key top 102, and rotatably fixes the pair of link members 103-1 and 103-2; the housing panel 107 that is mounted on the housing 201 of the information processing apparatus 200, and includes a first surface (front surface) to which the pair of link members 103-1 and 103-2 and the frame member 106 are fixed, a second surface (rear surface) that is a back side of the first surface, the through holes 107a into which the leg portions 106b are inserted, the through hole 107b exposing the dome rubber 104b, and the projection-shaped fastened portions 107c formed on the second surface; the membrane sheet 104 on which the dome rubber 104b is mounted, that is opposite to the second surface and includes the through holes 104n that are fitted to the screw holes 107c; the support plate 105 that is opposite to the second surface via the membrane sheet 104, and includes the through holes 105a that are fitted to the screw holes 107c; and the screws 108 that are fastened to the screw holes 107c.

Therefore, the membrane sheet 104 is not bonded to the rear surface of the housing panel 107 by a double-sided tape or an adhesive, and hence it is avoided that the membrane sheet 104 warps or transforms. Accordingly, the occurrence of the state keeping on turning on the contact 104e in the membrane sheet 104, i.e., the key-on state can be suppressed.

Moreover, according to the above-mentioned embodiment, the pair of link members 103-1 and 103-2 that vertically raises and lowers the key top 102 in conjunction with each other, and the frame member 106 in which a part 103d of the pair of link members 103-1 and 103-2 is fitted are mounted on the first surface (front surface) of the housing panel 107 that is mounted on the housing 201 of the information processing apparatus 200. The membrane sheet 104 on which the dome rubber 104b generating the reaction force against the depression force of the key top 102 is mounted is arranged opposite to the second surface (rear surface) of the housing panel 107 which is the back side of the first surface. The support plate 105 is arranged opposite to the second surface via the membrane sheet 104. The membrane sheet 104 and the support plate 105 are mounted on the second surface of the housing panel 107 by fastening the screws 108 to the screw holes 107c formed on the second surface.

Therefore, the membrane sheet 104 is not bonded to the rear surface of the housing panel 107 by the double-sided tape or the adhesive, and hence it is avoided that the membrane sheet 104 warps or transforms. Accordingly, the occurrence of the state keeping on turning on the contact 104e in the membrane sheet 104, i.e., the key-on state can be suppressed. Moreover, the dome rubber 104b does not contact the key top 102, and hence the inclination and the damage of the dome rubber 104b can be avoided.

Some preferred embodiments of the present invention have been described in detail, but the present invention is not limited to these specifically described embodiments but may have various variations and alterations within the scope of the claimed invention.

1. A key switch device comprising:
a key top having an operation surface;
a pair of link members that vertically raises and lowers the key top in conjunction with each other;
a frame member that includes a leg portion extending vertically downward and a first through hole which a reaction force generating member generating a reaction force against a depression force of the key top penetrates, and rotatably fixes the pair of link members;
a panel that includes a first surface to which the frame member is fixed, a second surface that is a back side of the first surface, a second through hole into which the leg portion is inserted, a third through hole which the reaction force generating member penetrates, and a projection-shaped fastened portion formed on the second surface;
a sheet on which the reaction force generating member is mounted, that is opposite to the second surface and includes a fourth through hole that is fitted to the fastened portion;
a support plate that is opposite to the second surface via the sheet, and includes a fifth through hole that is fitted to the fastened portion; and
a fastening member that is fastened to the fastened portion.

2. The key switch device according to claim 1, wherein
the support plate is an optical guide plate,
the panel includes a sixth through hole which passes a light from the optical guide plate, and
a character, a number or a sign which is processed transparently is formed on the operation surface.

3. The key switch device according to claim 1, wherein
the fastened portion is a screw hole and the fastening member is a screw.

4. The key switch device according to claim 1, wherein
the fastened portion is a hole and the fastening member is a pin.

5. A keyboard comprising:
a plurality of key switch device according to claim 1.

6. An assembly method for a key switch device, comprising:
mounting, on a first surface of a panel which is mounted on a housing of an information processing apparatus, a pair of link members that raises and lowers a key top in conjunction with each other and a frame member in which a part of the pair of link members is fitted; and
mounting a sheet and a support panel on a second surface of the panel by arranging the sheet, on which a reaction force generating member generating a reaction force against a depression force of the key top is mounted, so as to be opposite to the second surface of the panel which is a back side of the first surface, arranging the support panel so as to be opposite to the second surface via the sheet, and fastening a fastening member to a fastened portion formed on the second surface.
